(19) United States
(12) Patent Application Publication
(10) Pub. No.: US 2006/0123331 A1
(43) Pub. Date: Jun. 8, 2006

(54) Method and system of forms management in a call center

(76) Inventors: John Hightower, Salida, CO (US); James Anthony Webster, Salida, CO (US)

Correspondence Address: Susan D. Campbell, Esq.;Holme Roberts & Owen, LLP, Suite 1300, 90 S. Cascade Avenue, Colorado Springs, CO, 80903, US

(21) Appl. No.: 11/005,830

(22) Filed: Dec. 7, 2004

(51) Int. Cl. G06F 17/24; G06F 17/30; G06F 17/00

(52) U.S. Cl. 715/505; 715/507; 707/104.1; 707/3

(57) ABSTRACT

The present system and method are directed to a computerized system for selection, preparation and management of forms. The system and method are especially advantageous in a call center environment dealing with a large volume of customers and multiple forms. The system and method include the display of scripted questions to users at work stations that elicit the input of data regarding the customer, the data being utilized by the system to select, prepare and print relevant forms. A uniform interface including an omnibus script is provided to all users, and the system obviates the need for user selection of applicable forms for particular customers.

### BACKGROUND OF INVENTION

1. Field

The present system and method are generally directed to forms management and, more particularly, to forms management in call center environments.

2. Related Art

In some business environments, information is collected from customers for the purpose of completing selected forms among a pool of many forms. In order to handle high volume, such businesses often employ agents or operators, herein referred to as agents, to service multiple customer contacts simultaneously. Such businesses include call centers that handle applications, claims, and change request forms related to life insurance, health insurance, automobile insurance, and mortgage processing.

Generally, the agents in such businesses must decide which forms are relevant to a specific customer's needs. Significant resources must be allocated to the training of these agents, especially in businesses where the number of forms is large. In a call center handling nationwide insurance applications for multiple life insurance companies, for example, forms vary from state to state, as a function of differences in state law, and forms may also differ from company to company, depending on factors such as the company's insurance products and requirements for coverage. The complexity of the task facing the agent is compounded with the various types of forms used, such as application forms, change forms, medical forms, disclosure forms, financial questionnaires, consent forms, and hazardous activity forms. Consequently, thousands of forms must be managed. Also, when forms are changed, due to changes in the law, or changes in company requirements, for example, updating of the forms and management of updated forms present further challenges.

Some businesses use manual methods for managing forms, including filing and organizing hard copies of the various forms used. Other businesses maintain electronic copies of forms needed on a computerized system. In these businesses, agents are supplied with computer terminals, and, after the agent determines which form is needed for a particular purpose, the agent can retrieve and display the form on the computer terminal and then complete the form while viewing it on the terminal.

In other business environments, agents complete forms through a computerized system that utilizes a database program. Each form is reflected individually in the database, with the information required to complete the form entered as a series of fields, each field being entered as a separate column in the database. The agent then selects the relevant form and completes the form by completing each of the fields associated with the form in the database. Substantial programming resources are required in this system to establish the database, and to make changes in the database, the fields, and the user interface when the forms are changed, because each field is associated with a separate column in the database (and there may be many columns in a database).

This situation creates an enormous challenge in managing these forms especially in high volume call center environments. What is needed, therefore, is a method whereby the forms can be managed in a high volume environment that minimizes the necessity of agent training, reduces errors in form processing, increases the interactivity on the phone with customers, and permits updating without the need of a programming staff that is scalable and maintainable.

### SUMMARY

The present system and method are directed to selecting, completing, and managing forms. They are especially advantageous in a call center environment.

The present system and method include a computer system that operates to enable an agent or other user to select, complete and print forms on the basis of information supplied by customers to the agent.

In one embodiment, a preliminary component of the system and method is obtaining a set of forms and analysis of the set of forms to define the data required to complete each form. The system and method further involve determining commonalities in the data among the set of forms and developing a script of questions adapted to elicit such data and to determine which of the forms is best suited to the customer's needs.

In an embodiment, the computer system is a networked system that includes a server means that in turn includes a memory means and a processor means. The processor means is configured to include a program for defining and ordering the script of questions and developing a user interface design including panels of questions and fields for display to an agent or other user, and for inputting data in response to the questions of the script. The processor means also includes means for selecting, on the basis of data inputted in response to the script of questions, one or more forms best suited for the customer's needs. The computer system further includes a design database for storing one or more user interface designs, and a results database for storing data inputted by the user. These databases can be formed as two database structures, or as a single database structure. The system also includes a forms library means that stores forms and maps data from the results database means to forms selected by the system to produce a completed form, and form printing means for producing a printable form for each of the completed forms. The system includes work stations that are networked with the server means, each work station including an input means, an output means, and a printer means for printing forms The system can be configured with a plurality of work stations so that multiple users can access the system and use it to input data needed for forms preparation, selection, and printing at one time.

The present system displays questions to an agent or other user on a work station of the system in a format independent of the structure of forms used in the system, and provides fields in which data responsive to the questions can be inputted. After the responses to the questions are inputted by the agent, and the system selects the forms that are needed, the system completes the fields in the forms, and formulates and prints the forms in a specified order. In one embodiment, the data that defines the questions, the fields, and their relationship to the forms, as well as the data values supplied by the agent after consulting with a customer, are stored as data modules in a database structure or structures having at least three columns such that changes can be effected by adding data modules but without changing the structure of the database such as by adding columns. Accordingly, changes can be made in the scripted questions, the forms, and the screen interface seen by the agents without the expertise of a programmer or a database administrator. Additionally, a further embodiment includes a computer readable medium for providing and using such a database structure or structures.

The present system has the capability of presenting to the agent an additional set of questions in response to answers given to one or more previous questions. Through this method, the system will request the information needed for supplemental or alternate forms that may be required under certain conditions.

The system enables the design of a single user interface including an omnibus script of questions, or script design, that can be utilized by all agents and other users regardless of which specific form is being completed. Such single user interface reduces the need to train agents dramatically since knowledge of each individual form is not required.

The system also provides for passing a partially completed set of questions from one agent to another, the agents working at separate work stations. The process of taking information from a customer can begin with an agent having a low skill set to complete the initial part of the scripted questions, which consist of basic information such as customer name, address, and phone number. The script can then be accessed by another agent with greater skills to complete a further portion of the scripted questions. The script can then be passed to yet another agent to complete the rest of the questions. For example, in the case of a call center that processes insurance applications, the questions asking for basic information can be completed by a telemarketing agent, and then more complicated questions can be answered by a more highly compensated licensed insurance agent, and then by another agent to complete the rest of the questions. Similarly, the application can be passed from one queue to another consisting of agents having appropriate skills in call centers that support Automatic Call Distribution (ACD).

A further embodiment includes a method for providing on a computer system the means for selecting and completing one or more forms of a form set with data obtained from a customer.

Besides selecting the necessary forms and supplemental forms that are needed for a particular customer, the system and method can also screen the information supplied for omissions, inconsistencies, or conditions that require supervisory consent. This mechanism ensures that the proper forms are prepared and sent out without errors.

### DESCRIPTION OF THE DRAWINGS

FIG. 1 is a diagram of a network configuration for one embodiment of the present system.

FIG. 2 is a block diagram illustrating the components of the application management system.

FIG. 3 is a block diagram illustrating the interface means as it relates to the design database and the results database.

FIG. 4 is a block diagram illustrating the detailed database structure of the design database structure.

FIG. 5 is a block diagram illustrating the interaction of the agent with the interface means and the associated databases.

FIG. 6 is a block diagram illustrating the process by which a partially completed application is transferred from one agent to another.

FIG. 7 is an illustration of the relationship between the XML file generated by the forms library and the final form in PDF format.

FIG. 8 is a block diagram illustrating the process by which an administrator updates the forms library with the rules that govern the construction of the forms package.

FIG. 9 is a flow chart illustrating the use of a validation script.

### DETAILED DESCRIPTION

The present system and method are directed to the selection, completion and management of forms by businesses that handle and gather information to complete such forms. The system and method are especially advantageous in businesses, such as the insurance, real estate, mortgage, law, and banking businesses, that utilize multiple forms in handling customer needs. The present system and method can be utilized by one user or a plurality of users.

The present system includes a computer system that presents scripted questions to a user on the user's work station in a format independent of the structure of the forms used, then automatically selects the forms that are needed for a particular customer, the forms consisting of one or multiple forms based on information collected, completes the fields in the selected forms, and prints the forms out in a specified order.

A preliminary component of the present system and method involves the collection of a set of forms for use by the user's business. These may be obtained from any of a number of sources, such as private companies and/or governments. In some cases, the business may develop its own forms. This component then involves analysis of the set of forms to determine the nature of data requested by the forms, and possible overlap and commonalities in the data requested by the forms. In one embodiment, there may be only one form set, but in other embodiments, the system may process multiple form sets.

The system and method involve developing a script of questions for users to elicit data from customers needed to complete the forms of a form set, but also, on the basis of a portion of the data inputted, to select forms most relevant to the needs of the customer. For example, in the field of insurance, all forms in a form set may ask for the customer's full name, residence address and telephone number. The scripted questions, which also may be formatted as data requests or instructions for input of specified data, developed then would include initial questions asking for this information. The script might also ask for type of insurance product needed (e.g., life, auto, fire, home). The script might then provide further alternative lists of questions depending on the data inputted in response to the initial set of questions. For example, once the user inputs information concerning the customer's residence address (including the state where the customer lives), and the type of product desired (a new life insurance policy), the script will provide questions needed to complete life insurance application forms compliant with the state where the customer is resident, including questions, for example, about the customer's health history, smoking and drinking habits, recreational interests and the like. For a customer needing auto insurance in another state, an entirely different set of questions would be developed and provided. The data inputted in response to these questions and others will in turn determine whether one company's policy versus that of another company is most applicable to the customer. When the questions have elicited data sufficient to identify a specific company's policy as the best fit for the customer, another set of questions may need to be asked to gather the remaining data needed to complete the forms needed for that policy. In some embodiments, there will be a separate form set for each company or business unit, each form set having a different script of questions and instructions.

The scripted questions are introduced onto the computer system to be used by one or more users who interface with customers. Any of various types of computer systems can be utilized, although in the present embodiment it is contemplated that the computer system is networked, and includes a server means, having a processor means and memory means, as well as one or a plurality of work stations for use by users, each work station configured with an input means to receive agent inputs of data in response to scripted questions, an output means to display questions, fields and data inputted, as well as completed forms, and a printer means for printing forms produced by the system. The server means and work stations are connected by a cable means for receiving and sending questions, data and forms and other information processed by the system. Other network configurations can be utilized, and the present description is not intended to limit the system and method to a single configuration. For example, the printer means can be separate from the work stations, and linked directly to the server.

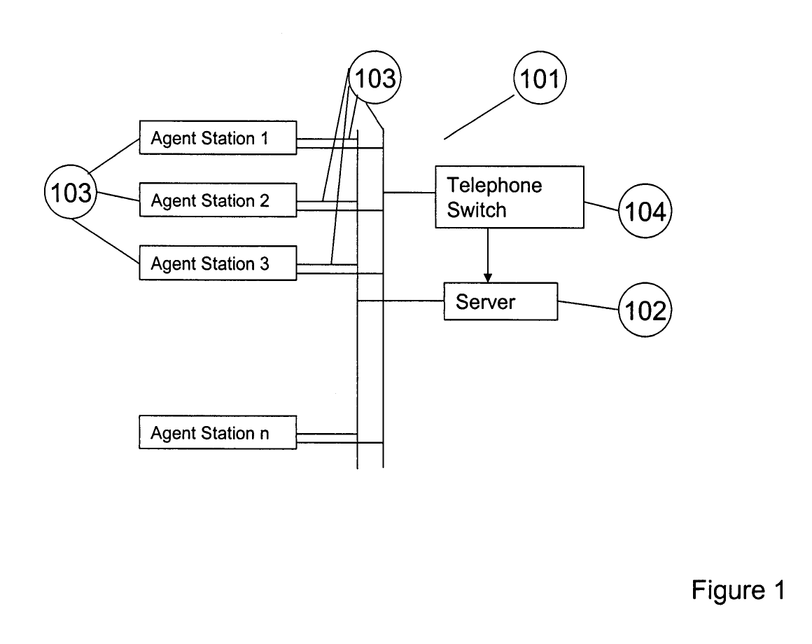

In the present embodiment, and referring to FIG. 1, the system resides on a call center network (101) that includes at least one server (102), a connection means (103) for connecting the components of the network, a telephone communications means (including a telephone switch in the present embodiment) (104) and agent work stations (105). One server or multiple servers can be used in the present system. This system has the capability of transferring a call and the associated computer screen information from one agent work station to another, coordinated through communication between the telephone switch and the server. In the present embodiment, which is a server/client system using an Atlas server/client software system, the processing functions of the system principally reside on the server, and generate the screen display for inputting data on an agent's work station. Other computer system configurations can be used, as will be appreciated. For example, the processing functions can be loaded primarily on the workstations, or entirely on one or several personal computers that operate individually or that are linked. Further, the system can operate independently of or without a telephone communications means.

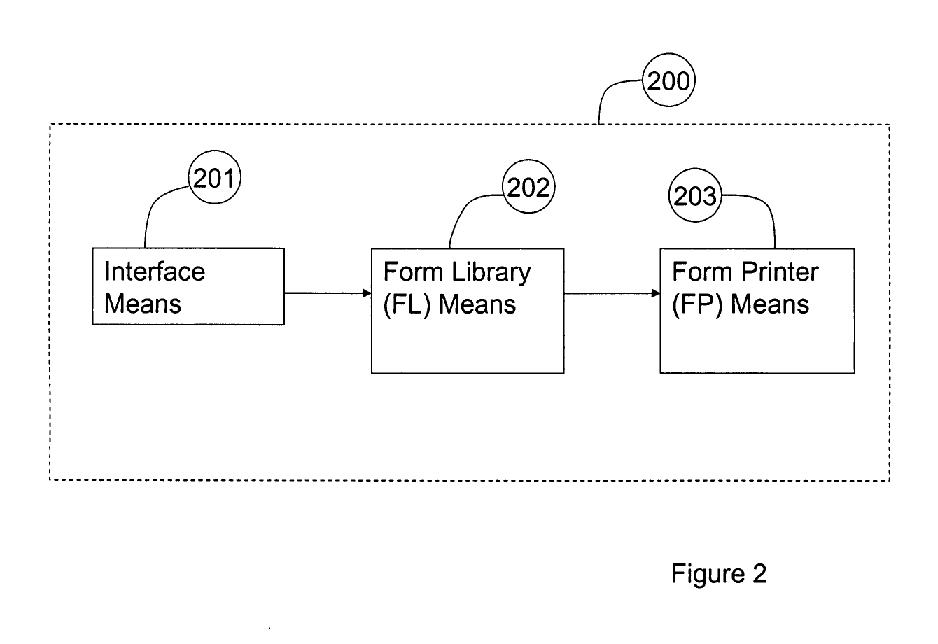

Referring to FIG. 2, the application management system (200) of the present embodiment consists of three segments: The interface means (201), the forms library means (202), and the form printer means (203). The interface means (201) provides means, such as a computer program residing on the server means, for users to collect data and to define the user interface screens utilized at the workstations in collection of data. In some applications of the system, one class of users (such as insurance agents) interfaces with customers, while another class of users (such as company administrators) develops scripts and defines the screens that display questions to the first class of users. The forms library means (202) provides means of applying a set of pre-determined rules to produce a collection of forms, and for a user to define the pre-determined rules. The form printer means (203), provides means for creating a package of completed forms and for a user to define the rules for creating the package.

The interface means interacts with the database structures of the system. In the present system, the database structures are housed in Microsoft® Sequel programming. In the present embodiment, the interface means, database structures, and the forms library and form printer means are all computer programs that reside on the server means of the network. In the present system, there are two database structures, a design database structure and results database structure. In another embodiment, all or a portion of these programs can be loaded onto a computer readable medium such as a compact disk, floppy disk, or a hard drive, including a Zip drive, portable hard drive or external hard drive, or a USB mini drive. In a further embodiment of a computer readable medium, all or a portion of the programs are downloaded from a server accessible over the Internet for downloading to a computer system such as a personal computer or the server of a networked system.

As will be appreciated, the present system and method include a method, on a computerized system as described herein, of providing the interface means, one or more database structures, forms library means, and forms printer means as well as or in the alternative other programming functions as described herein.

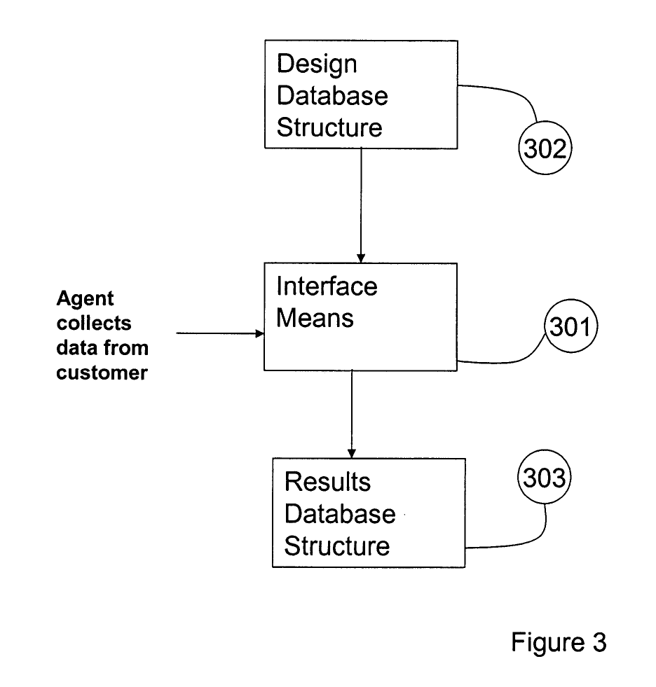

Referring to FIG. 3, the interface means (301) interacts with a design database structure (302). The data introduced into this design database structure defines the user's screen design in a manner that makes it possible for an administrator or other user without programming or database expertise to make modifications. Typically, data in databases are stored in a series of rows that make up individual records and columns that make up fields within those records. A new record or row, also called a data module, can be added by a program without making material changes to the database. However, when a field is added within a record, a database administrator typically adds a column to the database and a programmer makes changes to the interface program that utilizes that to paint the desired screen. Correspondingly, when a field is added or modified in a form, a corresponding change must be made in the database by personnel having the necessary technical database and programming expertise.

In the design database structure of the present embodiment, the database fields within the database consist of at least three fixed columns—a CollectionID, a field name, and a field value. A data module is made up of the collection of data that share the same CollectionID. In order to add a field, a new data module (or row) having the same CollectionID is added. This can be done by a program without any structural changes to the database.

Though a minimum of three fields are required for the data collection structure of the database of the present embodiment, it is possible in other embodiments to design systems that may include more. For example, an additional field might be added that indicates a security level that must be satisfied for a given user of the system to make a change to a selected form. In another example, additional fields can be added to track which users have made changes to a given record and when those changes were made in order to create a system that tracks revision history. Once the number of columns is initially set, the information in the database is changed or supplemented by adding or deleting data modules and not by adding columns, such that the structure is fixed.

The database structure above is used in conjunction with the interface means. The interface means is a computer program capable of reading, writing, and manipulating data in the design database structure, and utilizing this data to form or paint a screen display on the agents' workstations. The data in the design database structure defines a set of data requests, preferably in the form of questions, the logic of how those questions are to be presented to the agent, the fields, default values, and all other information required to form the agent's screen display. These screens are organized in a series of panels, each panel containing questions and fields which are to be completed by the agent. Within this design, each of these panels and fields can be specified to be made visible or invisible in real time based on answers given to one or more questions of the script. In this way, questions and sets of questions are added or removed from the agent's display interactively, in response to data inputted by the agent. In one embodiment, this script is stored in an XML format, and is stored in a single file for each company's application. As will be appreciated, the questions and sets of questions can be organized in a decision-tree format, which in turn helps to determine the forms relevant to the data collected from responses to the questions.

The interface means also includes a means of storing the data obtained from one or more customers in response to the script, also called the customer data values or results, in a results database structure (303). As information is collected and inputted by the agent, the inputted information is stored in the results database structure (303). In one embodiment, the design database structure and the results database structure are separate databases. In another embodiment, these databases reside in a single database.

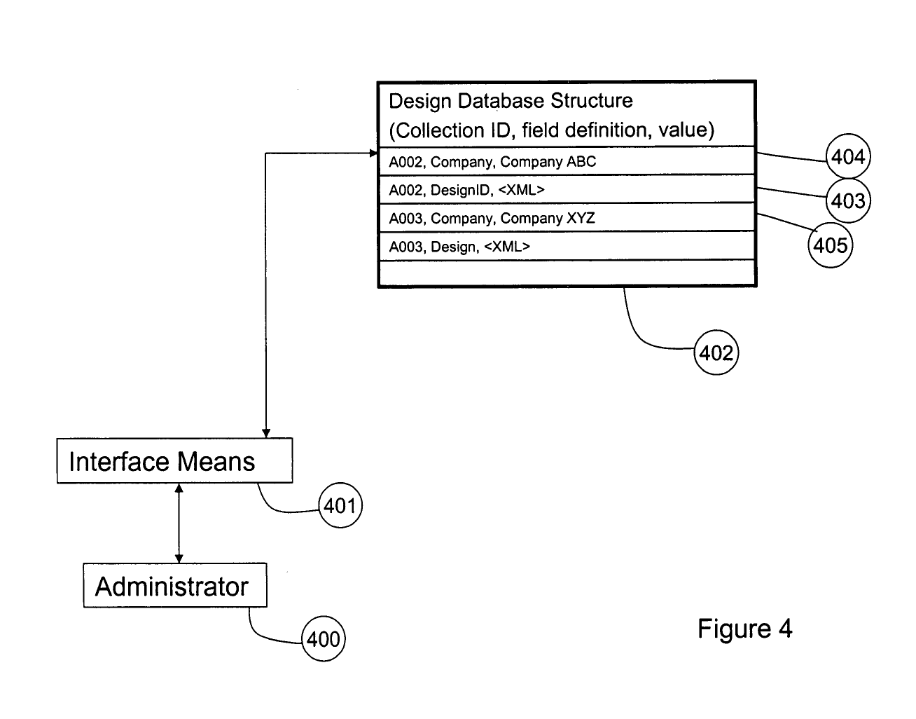

FIG. 4 illustrates one embodiment of the design database structure in detail. The user interface design is defined by an administrator (400). The interface means (401) enables the administrator to define the user interface design for a particular form set. The interface means includes a program that displays a screen to the administrator reflecting the design data in the design database structure. Specifically, the administrator can add questions, fields, new panels consisting of questions, default values, colors of the fields, and all other attributes associated with the design of the screens of the user interface design to be displayed to the agent. In one embodiment, this information is stored in an XML formatted file. The XML file is stored in the design database structure (402) with an association to a CollectionID, an arbitrary but unique identifier number, utilizing a data structure herein referred to as a data module. The data module consists of at least three columns, namely the Collection ID, the Field, and the value of that field. In the case of the data module that defines the screen design, for example, the CollectionID might be A002, the name of the field is DesignID, and the value is the name of the XML formatted file (403).

Other data associated with this user interface design is stored using the data module structure with the same CollectionID, and the field and associated value as appropriate. For example, the design might be associated with a specific company, Company ABC. In this case, the data module defined would be “A002, Company, Company ABC” (404). Other information associated with this design can be stored in the design database structure in a similar fashion.

Multiple user interface designs can be stored in the design database structure by associating a different CollectionID with each design. For example, the screens to be used when filling out application forms for Company XYZ, could be associated with Collection ID A003 (405). A single user interface design can be developed for each company and its form set, so that agents wishing to prepare forms for a specific company would all use the same user interface design.

Modifications to these user interface designs can be accomplished by an administrator not having programming skills or database skills. Such modifications are achievable by permitting the administrator to choose a given CollectionID, and operating on that data. Selection can also be made by some other indicator, such as a Company. The associated CollectionID will be determined by the data module entry specifying the Company as the Field and the specific company sought as the value. When the CollectionID is identified, the value of the data module that has the same CollectionID and a Field of DesignID will specify the XML file to be opened.

In one embodiment, the definition of these user interface designs includes a scripting language that can be used to manipulate panels and questions within a panel. For example, a question may ask whether the applicant was born in the United States. A script can respond by making visible the city and state fields if the question was answered “yes”, or can make visible “what country” and “Are you a US Citizen” fields if the question was answered “no”.

Scripting can also be used to invoke a complete panel of questions. For example, if the question “Do you have any other life insurance in force?” is answered “no”, then there is no need to display the panel to collect information about other insurance. If the answer is “yes”, then a panel to collect information about these other policies is displayed. If it is determined that the applicant is replacing insurance according to the definition of a particular state, then the panel of questions regarding this replacement is also made visible.

These scripts can also operate over a set of panels to perform much more powerful and complex operations. For example, a script could calculate a “score” based on beneficiary designation, credit score, health history, income, tobacco usage, and a number of other factors that modified the process based on an internal scoring system. This score can then be used to modify the process of that particular application. If, for example, the score indicates that the application may be a credit risk, up front payment may be required. If the score indicates some marginality, a manager's approval may be needed before the application is submitted.

Another example of the use of the scripting language is validation. Applications can be validated before printing for completeness. Such validations can include informational validation in which potential problems with the applicant are identified, error validation checks for critical data that is missing, and management override validation in which factors are identified which require management approval before the application is submitted. Scripting can be invoked to add or clear these validations.

Scripting can also be used to guide agents through the information collection process and gives instructions to the agent at the appropriate points in the application process. For example, the agent may be asked to read a disclosure statement before collecting certain information. The system will display appropriate panels and fields depending on certain customer variables. Such variables may be specified on the fly, and may depend on how given questions are answered. Examples include additional questions that may be required for applications in a certain state, the type of application sought, change notifications that may be needed, and certain disclaimers that are needed.

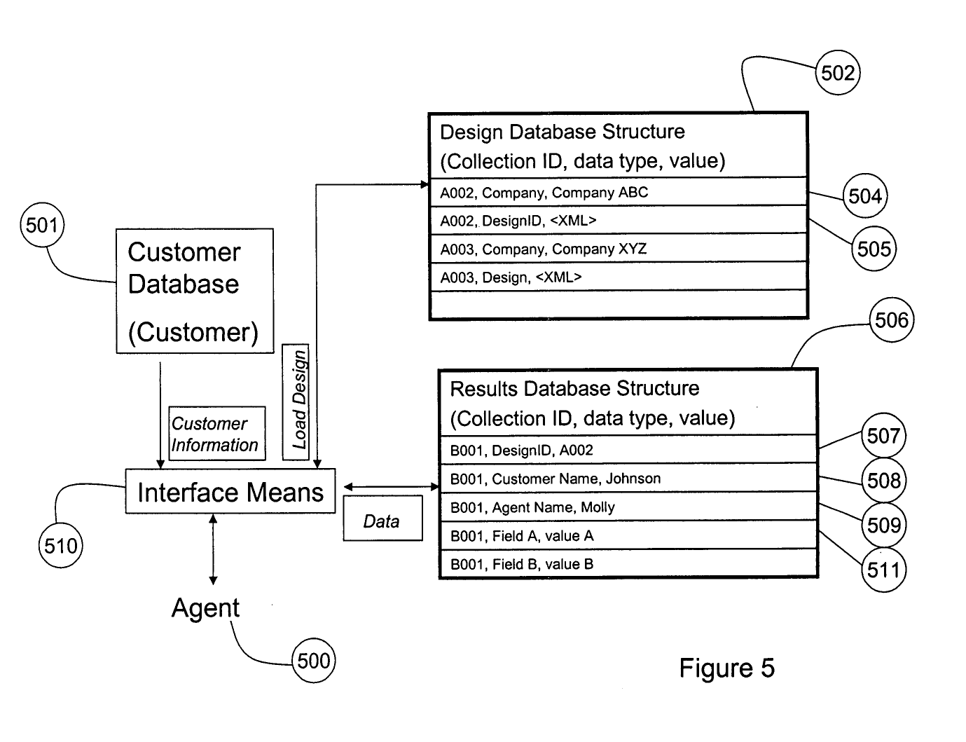

As depicted in FIG. 5, in a further embodiment, the system also includes a customer database (501) for storing previously collected customer information. FIG. 5 also illustrates the interaction of the agent (500) with the design database structure (502) and results database structure (506). The process begins when an agent selects or enters a customer name into the customer database. Some customer information may already be present in the customer database before the customer call begins, either because the call center has interacted with the customer previously or because the call center has obtained a list that contains that customer's name. In one embodiment, this customer data is stored in the results database structure format (506). In another embodiment, customer information is stored in the customer database (501). In the present embodiment, data pertaining to the application must be stored in the results database structure (506) in order to capitalize on the capability of easily making changes to the underlying forms by an administrator without programming knowledge. As discussed previously, if this data were stored in the typical row/column structure of a relational database, changes made to the forms would require a qualified database engineer and a software programmer to made corresponding changes in the software. However, it is not imperative that certain customer data is stored in the results database format since the structure of that component of data is unlikely to change. If customer data exists in a separate customer database (501) (which can be a relational database), this data can be automatically transferred to the appropriate record of the results database structure (506) when an application is started, thereby saving the agent the work of entering that data manually. Alternatively, the customer data can remain in the customer database, and a record in the results database structure (506) can refer to that data in the customer database (501).

In cases where the customer data already exists in the customer database, information from the telephone communication means could automatically access the record in question by passing information from the telephone communication means to the customer database through the interface means. Such information can include automatic number identification (ANI), Caller ID, and information entered by the customer from an Interactive Voice Response (IVR) system.

The customer information may additionally contain historical data regarding the customer which may be used to modify the business process with that customer. For example, the customer may have requested an application for service in the past, but was ultimately turned down for the service or refused the service after the application process is complete. In this case, the business process for this customer might be modified to increase the probability that the customer will be converted to a successful sale in a new application process, perhaps by requesting an up front payment or asking additional qualifying questions.

If a given customer's information is not found in the customer database at the start of the application process, then the agent will collect and enter the appropriate information. The agent then selects an appropriate company for which the application is being completed. Alternatively, the company could also be selected based on a set of questions, wherein the interface means automatically selects the best company given the answers submitted by the customer.

As an illustration, the process of selecting the user interface design for a given company (the company having a form set particular to its business) is described as follows: The interface means (510) queries the design database structure to find the CollectionID that corresponds to that company (504). In this illustration, the interface means finds the data module that defines the entry screens for Company ABC, this data module being one where the data type is “Company” and the value is “Company ABC”. The CollectionID field of that data module will identify the collection of data that corresponds to the company Company ABC, in this case “A002”

In one embodiment, the entry screen is defined by means of an XML display file which is loaded to the computer terminal of the agent's work station. The specific XML file in question is identified by a data module having the CollectionID number that was identified as corresponding to Company ABC (A0002) and a data type corresponding to the information sought, in this case “DesignID” (505). The value of that data module contains the XML file, which is then loaded to the computer terminal of the agent's work station. The agent now has the set of screens for the user interface design which is to be used to collect customer data necessary to select and complete the most relevant frame from Company ABC's form set.

All data specific to the caller's application is stored in the results database structure (506). When the agent has selected the company for a given customer's application, data modules are automatically entered into the results database means. This is done by generating a new CollectionID that will correspond to that caller's application information. A new data module is then written into the results database structure that associates that application with a given display in the design database structure. If, for example, a collection ID of “B001” is generated for that particular caller's application, and the CollectionID of the selected screen design is “A002”, then a data module “B001, DesignID, A002” is entered into the results database structure (507). In one embodiment, the association of this CollectionID to the customer is made by storing that CollectionID an identification that refers to a record in the customer database (501) in association. In another embodiment, the association is made by entering one or more additional identifiers in the results database means in association with that CollectionID. For example, an entry “B001, customer name, Johnson” (508), would make such an association. Other information could be entered in the results database structure (506) in a similar manner, such information being the agent's name (509), time and date of the call, caller's birth date, social security number, phone number, and address.

The agent then proceeds to ask questions of the caller as directed by that agent's screen. As the agent completes a field on the screen, this value is stored in the results database structure (506) using the data module structure. All data entered into the results database structure (506) in association with a given application will have as the CollectionID field the number that corresponds to the application being completed. Each field that is filled in on the agent's screen will be stored as a single record in the results database structure, each having the Collection ID corresponding to the application, a “data type” corresponding to the name of the field on the agent's screen, and a “value” corresponding to the data that was entered by the agent for that field. If, for example, the agent completes “field A” with value A in the application corresponding to CollectionID B001, then an entry is made into the results database structure as “B001, Field A, Value A” (511).

Data can also be automatically collected by means of gateways to other computer programs. Such gateways assist the agent in automatically completing portions of the applications. One example of this was the aforementioned customer data insertion from a customer database. Another example is credit information pertaining to a given customer by automatically collecting by connecting to the services of a remote credit bureau. Such connection can be established through a private network or through the Internet. Another illustration of this principle is the connection to a quotes engine that will automatically insert data concerning the cost of the service for which the customer is applying. Such quote engines could reside at a remote site, on the local network, or even on the individual agent's workstation.

In another embodiment, data values are entered by an agent or directly by the caller through a web page on the Internet. Entered data values are stored in the results database structure in the same manner as described above, regardless of the type of screen used for input.

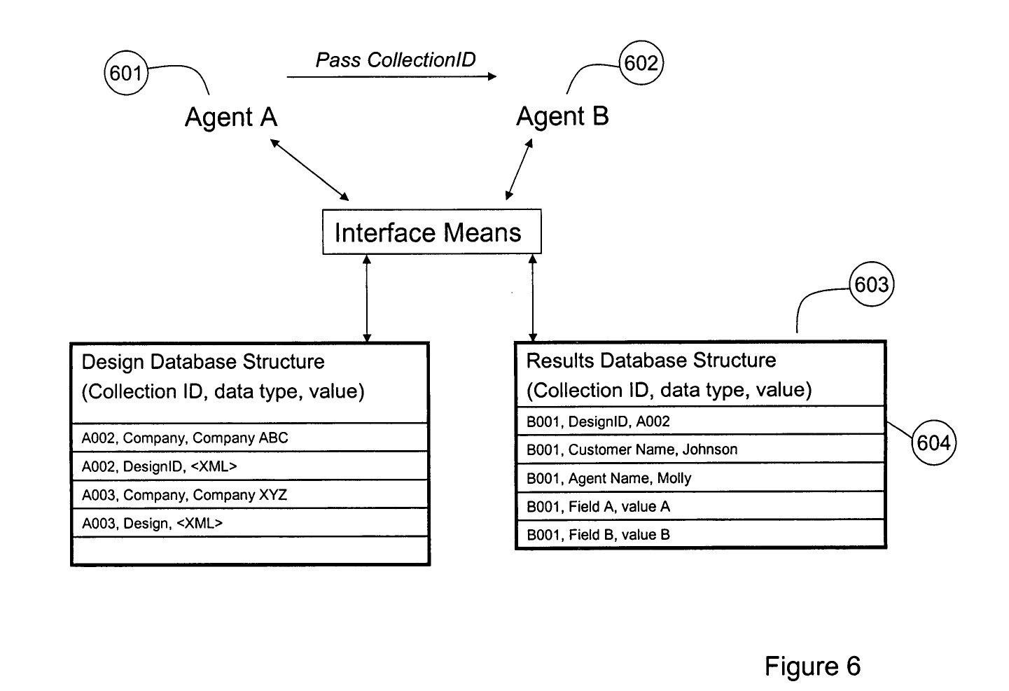

FIG. 6 illustrates the process by which a partially answered script of questions is transferred from one agent to another. This is accomplished by passing from Agent A (601) to Agent B (602) the CollectionID corresponding to a partially completed script. Agent B can then access the results database structure (603) to find the data module having that CollectionID and having a Field of DesignID (604). The value of that data module identifies the XML file that defines the screen, which is then loaded to the screen of Agent B. Now Agent B can access the results database structure (603) to collect all field/value pairs that have been completed so far by finding all data modules with the same CollectionID. The current state of the application is thereby reconstructed on the screen of Agent B.

The capability to transfer from one agent to another provides the means for business flows which involve multiple agents effectively completing the form that is eventually produced. A telemarketing agent could take the caller's profile information, and pass that screen and the call to a licensed agent, as required by regulation. With another transfer, a non-licensed agent could then complete the question-and-answer process. This capability provides the means for more effectively managing agents. Highly compensated licensed agents now reduce their time per script, allowing them to handle a higher volume. Similarly, the transfer could be made from one queue consisting of appropriately skilled agents to another queue in call center systems supporting Automatic Call Distribution (ACD).

When the script is complete, the forms library means maps the collected data to the fields in the selected forms. The forms can be stored in any format. In one embodiment, the forms are stored in PDF format. Based on the collected data, the forms library means creates an XML document that defines one or more forms that make up the package, providing, among other things, the fields on each form, the specified field attributes (such as font size, color, rotation, background), and the data for each field.

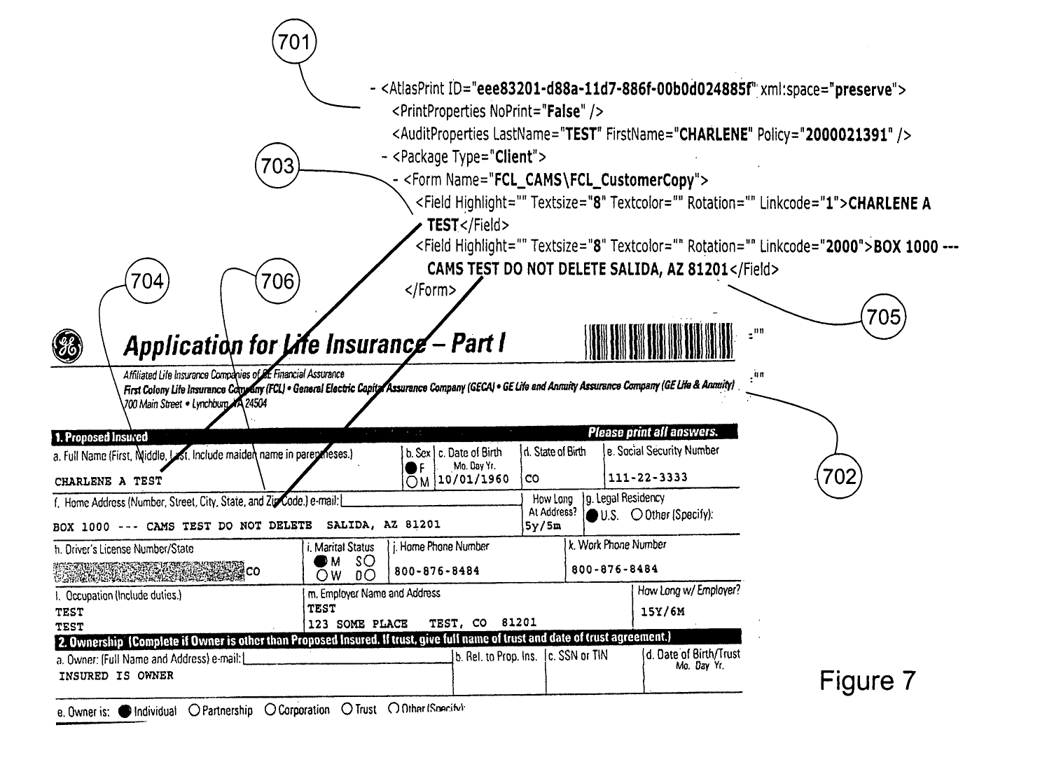

FIG. 7 illustrates the relationship between the XML document (701) created by forms library means and the PDF file (702) that represents a portion of the final form. The forms library means defines the packages for each company, the forms within each package and the fields on the forms. In this particular illustration, the name field “Charlene A. Test” (703) as specified in the XML document was inserted into the PDF document in the appropriate location (704). Similarly, “CAMS TEST DO NOT DELETE SALIDA, AZ 81201” (705) as specified in the XML document was inserted into the PDF file (706). The entire package is defined by this XML test, encompassing multiple PDF files.

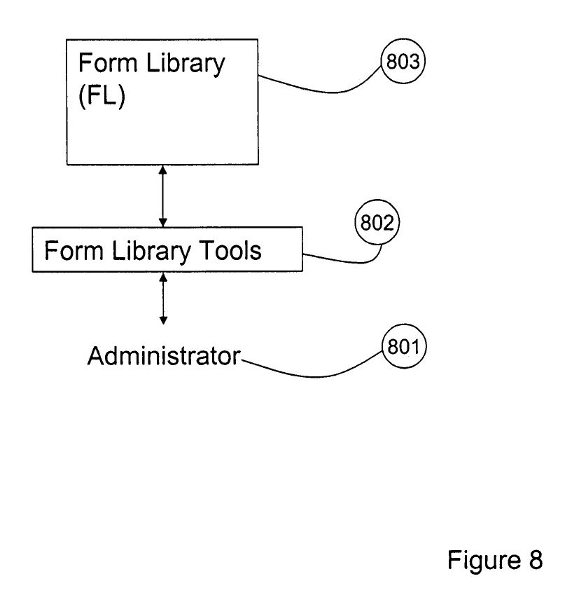

FIG. 8 illustrates the process by which an administrator defines the rules governing the forms library means. The administrator (801) utilized a forms library tool (802) to define the rules within the forms library means (803). With this tool, the fields on the form are mapped to corresponding fields in the XML formatted design contained in the design database structure. Field properties such as background color, foreground color, highlights, font type, font size, default values, and field rotation are also defined. The resulting values are stored in the forms library means. These rules will be used as a foundation for generating the XML file defining the final form.

Supplemental forms are also part of the package generated by the forms library means. These supplemental forms are inserted into the package as necessary based how one or more questions were answered. Such supplemental forms include various disclosure forms, such as HIV consent forms, Fair Credit Reporting Act consents, and various other forms required by the federal government and individual states, overflow forms for data that does not fit into the space permitted by the form, hazard forms, and replacement forms. Such supplemental forms can also include internal forms such as cover pages, invoice, quotes, and special instructions to the customer.

The forms library means can also be used to have the capability of defining multiple instances of the same form. For example, a separate travel form may be required for each trip taken abroad.

In one embodiment, the point size of the font is automatically reduced if the text cannot fit into the specified field length. If the data is too long even at the reduced font size, an overflow page is automatically generated. The overflow logic is also defined in the forms library means though the forms library tool.

In another embodiment, forms can create “child” forms that “inherit” characteristics from a parent form. This feature can be utilized in cases where forms that look quite similar can inherit most, if not all, of their fields from a parent so that the field mapping does not have to be duplicated. For example, in the insurance business, there are many different state variations of applications to cover all 50 states. However, many of these forms are quite similar. The differences may be no more than the wording of some disclaimer or disclosure text and/or wording of a question or two. Sometimes there might be a “special” question only asked in that state. Instead of mapping this form 50 times, the present system and method map a “parent” form. Then, each state “inherits” from this parent. The only matters mapped on any individual state then are the specific “data” differences. If the only difference is text or layout, no additional mapping is needed.

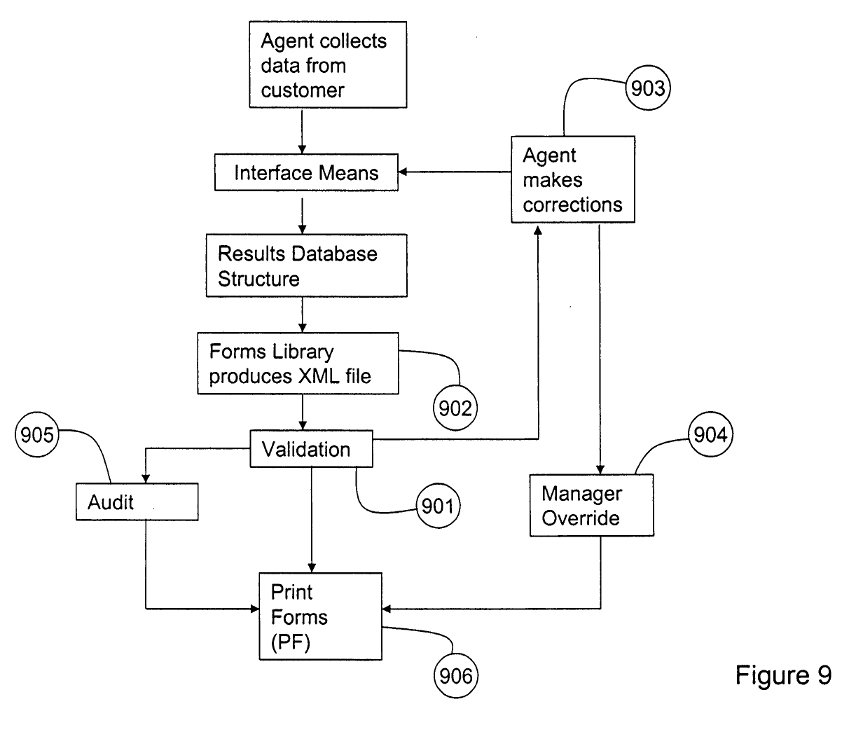

FIG. 9 illustrates another embodiment in which the scripting capability within the forms library means is utilized to validate the package for completeness before it is printed. The validation script (901) is operated on an XML file that is generated by the forms library means. Such validation can provide informational feedback to the agent regarding potential problems or errors such as critical missing data and inconsistencies in the data inputted (903). The validation can also identify conditions requiring special approval by management before the inputted data is processed (904). The validation can also select certain data collections for audit before processing continues (905), with selection done randomly or by formula. Validation can also be enabled or disabled for a given panel or a given data collection based on certain conditions. For example, if {conditionA is true} then validate(parameter1, parameter2).

The form printer means (906) picks up the XML document generated by the form library means after the validation passes, creates packages of filled forms, fills and formats the form field as defined, and prints the packages to a printer.

A further embodiment of the invention includes a method on a computer system for selecting and completing at least one form of a form set with data obtained from a customer. The form set is analyzed to define a script of data requests, the responses to the script as provided by customers providing data to select and complete a form. The steps of the method include, on a computer system, having a processor component, interconnected with a memory component and input and output components, providing means for storing said form set on said memory component; providing an interface means for defining a user interface design to display said script to a user on the output component and for inputting customer data on the input component in response to the script; providing a results database structure interactive with the interface means for storing customer data in response to the script, the data being stored and organized by customer and according to the user interface design; providing a means for selecting at least one form of said form set from the memory component on the basis of inputted customer data; providing a means for mapping customer data in the results database structure to the selected form, defining a completed form; and providing a means for printing the completed form.

In a further embodiment, the method includes the step of providing a design database structure, interactive with the interface means, for storing data defining the user interface design.

In other embodiments of the method, the interface means is operable to store data defining the user interface design in the design database structure and to retrieve and load said data on a selected output component to provide an interactive visual display on the output component; the results database structure and the design database structure are a single database structure; the system includes a plurality of input and output components operable to be utilized by a plurality of users; and the interface means is operable to define a user interface design including an interactive screen display of a script and inputted data in response to the script, the method further comprising the step, following the input of a first portion of data by a first user in response to the user interface design, of providing means for retrieving the screen display with the first portion of inputted data, and inputting a second portion of data in response to the user interface design.

A further embodiment includes a step of providing a means for storing a plurality of form sets on the memory component, and wherein the computer system is operable to select and complete forms from a plurality of form sets, and wherein the interface means is operable to define a uniform user interface design for each form set of the plurality of form sets, and wherein data representing each user interface design is stored in the design database structure.

In another embodiment, the method includes the step of providing a customer database means to create a customer database for storage of customer data, and providing means for retrieving stored customer data from the customer database for input to the results database structure in response to the user interface design, relieving the user from obtaining customer data from a customer; and, in a variation on this embodiment, the method includes also the step of providing telephone communications means connected to the computer system, the telephone communication means being operable by the user to receive calls from customers, and providing a caller identification means for identifying customers placing calls on said telephone communications means and retrieving customer information relating to the customers from the customer database.

In yet another embodiment, the method includes the step of providing telephone communication means connected to the computer system, the telephone communication means being operable by the user to receive calls from customers.

In one embodiment of this method, the results database structure can include at least three columns, the database structure operable to store a plurality of data modules, each data module including information provided by a selected customer in response to a specific data request of the script, each data module including a customer identifier for the customer providing information included in the data module, a data field for identifying the data request of the data module, and a data value for storing information provided by the customer in response to the data request of the data module. In the embodiment of the method including a design database structure, this structure can include at least three columns, the database structure being operable to store a plurality of data modules, each data module including information concerning a user interface design, each data module including an identifier, a field for describing the form set associated with the user interface design, and a file including the interface design for the form set of the interface design.

As noted above, another embodiment of the invention includes a computer readable medium for providing and using a database structure as described herein for selecting forms from a plurality of form sets and completing the selected forms with customer data. In one embodiment, the medium includes: a program for defining user interface designs, each user interface design including a plurality of data requests in a script format applicable to the forms in a selected form set, the data requests designed to prompt the user to input customer data used by the program to select and complete forms most relevant to the customer from the forms of the form set; a design database for storing the user interface designs, the design database including at least three columns and being operable to store a plurality of data modules, each data module having at least three items of information including an identifier, a field for describing the form set associated with the identifier, and a file containing at least a portion of each user interface design developed for the form set, modifications to the user interface designs being made by adding or deleting data modules and not by altering the database structure; a results database that, on selection of an interface design from the design database, stores customer data obtained from customers in response to the script of the selected interface design, the results database including at least three columns and having data modules, each data module having at least three items of information, including a customer identifier, a data field associated with each data request in the script, and the value of the data field including customer information responsive to the data requests in the script associated with the data field; a program for selecting a user interface design from the design database, displaying the design on a user screen display, and for inputting data values into the results database in response to the user interface design; and a program for selecting at least one form from the form set and mapping data from the results database to at least one form, to provide a completed form.

In this embodiment, the design database and customer information database can constitute one database, and each form set can be a plurality of forms provided by a business entity.

In addition, each script of data requests can be developed by analyzing the set of forms associated with the user interface design, to develop a set of questions organized in a decision tree format, the answers to which questions aid selection of a form of the form set and provide information to complete the selected form.

In other alternative embodiments of the medium, the medium also includes a means for linking the medium with a computer program outside the medium for obtaining data to be utilized by one or more of the programs of the medium; means for entering customer data to the results database transmitted through a web page accessed over the Internet; means for validating customer data inputted into the results database; means for calculating a score as customer data is inputted in response to the script, the value of the score affecting the presentation of data requests in the script and the form selected for particular customers; and means providing access to multiple users for modifying customer data inputted in the results database through entering the customer identifier of each such customer.

In another embodiment, the medium includes also a program for instructing a printer to generate a printed form for each a completed form.

The computer readable medium can be a compact disk or floppy disk; a hard drive (such as a Zip drive, USB mini-drive, portable hard drive, or external hard drive); or an electronic download of programs from a server accessed over the Internet.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A computer network for selecting and completing multiple forms with data provided by a user, said computer network comprising:
server means including processor means and memory means for receiving, sending, storing and processing a plurality of forms, and for receiving and storing data values, said server means being operable to define and order data requests and data fields into a user interface design for display to a user prompting the input of data values by said user, and said server means being operable to select and complete at least one form from said plurality of forms on the basis of data values received in response to said user interface design, thereby defining at least one completed form;
at least one station remote from and connected to said server means, said at least one station including input and output means to display visually to a user said user interface design, and to receive data values inputted by said user in response to said user interface design, and means for receiving from and sending to said server means said user interface design, said plurality of forms and data values inputted in response to said user interface design;
connection means to interconnect said server means and said at least one station for the transmission of said user interface design, said plurality of forms and the data values therebetween; and
form printing means for producing a printed version of said at least one completed form.

2. The network of claim 1, wherein the server means includes an interface means that is operable by a first user to define said user interface design.

3. The network of claim 2, wherein the interface means is also operable by a second user to load said user interface design on said station and to input data values on the input means of said station obtained from customers in response to said user interface design.

4. The network of claim 3, wherein said server means also includes a results database structure for storing said data values inputted by said second user in response to said user interface design.

5. The network of claim 4, wherein said results database structure includes at least three columns, the database structure being operable to store a plurality of data modules, each data module including information supplied by a selected customer in response to a data request of the user interface design, each data module having at least three information items, including an identifier, a data field for identifying the data request of the data module, and a data value for storing information provided by a customer in response to the data request of the data module, the information in the database structure being modified by adding or deleting data modules.

6. The network of claim 5, wherein said server means includes a forms library means for storing said plurality of forms and for mapping data values stored in said results database structure to at least one selected form to define said completed form.

7. The network of claim 2, wherein said server means includes a design database structure that is operable to store said user interface design.

8. The network of claim 7, wherein said design database structure includes at least three columns, the database structure being operable to store a plurality of data modules, each data module having at least three information items, including an identifier, a data field, and a data value of each said field, the data modules including data values that define said user interface design, and the design database structure enabling the user to modify the user interface design by adding or deleting data modules without re-programming the database structure.

9. The network of claim 4, wherein said server means includes both said results database structure and a design database structure that is operable to store said user interface design.

10. The network of claim 9, wherein said results database structure and said design database structure constitute a single database structure.

11. The network of claim 1, comprising a plurality of stations interconnected to said server means, each station having an input and an output means and being operable by at least one user of a plurality of users.

12. The network of claim 11, wherein said user interface design is operable to be accessed and loaded by each station of said plurality of stations.

13. The network of claim 12, wherein a first user of said plurality of users working at a first station accesses and loads said user interface design, and inputs a first portion of data values obtained from a first customer, and a second user accesses and loads said user interface design, accesses said first portion of data values, and inputs a second portion of data values obtained from said first customer, the server means then defining a first completed form from said first and second portions of data values that is thereafter printable by said form printing means.

14. The network of claim 11, further comprising a telephone switch, and wherein each said station also includes telephone receiver equipment, the telephone switch and telephone receiver equipment being operable to receive telephone calls from a plurality of customers and to enable users to obtain information from said plurality of customers that can be inputted in response to said user interface design.

15. The network of claim 13, wherein said network is a call center network for processing insurance forms, and wherein said first user is a non-licensed agent, and said second user is a licensed agent, and the completed form is an insurance form for said first customer.

16. The network of claim 1, wherein the data values inputted in response to said user interface design are utilized by said server means to calculate a score that determines payment terms.

17. The network of claim 1, wherein said server means includes a validation means for checking the inputs of data values by each said user for completeness.

18. The network of claim 1, wherein said server means includes a validation means programmed to conduct risk factor scoring on the basis of inputted data values, and on the basis of the presence of certain risk factors, to require supervisory authorization inputs for selection and processing of forms.

19. The network of claim 1, wherein said plurality of forms includes application forms for obtaining insurance policies sought by said customer, and the data requests of said user interface design prompt said user to request that each customer supply data values that the user inputs at the user's station, the server means utilizing said customer's data values to select the most applicable insurance policies and forms for said customer.

20. The network of claim 1, wherein said connection means is a cable connection.

21. The network of claim 1, wherein said connection means is a wireless connection.

22. The network of claim 1, wherein said connection means is an electronic connection utilizing the Internet.

23. The network of claim 22, wherein the user is a customer and said station is the customer's personal computer, the network being operable for the customer to download the user interface design and input data values directly that are transmitted to said server means over the Internet, the server means operable to generate a completed form on the basis of data values inputted by the customer.

24. A method in a computer system for selecting and completing at least one form of a form set with data obtained from a customer, said form set having been analyzed to define a script of data requests, the responses to said script as provided by customers providing data to select and complete a form, comprising the steps of:
on a computer system, having a processor component, interconnected with a memory component and input and output components, providing means for storing said form set on said memory component;
providing an interface means for defining a user interface design to display said script to a user on said output component and for inputting customer data on the input component in response to said script;
providing a results database structure interactive with said interface means for storing customer data in response to said script, the data being stored and organized by customer and according to said user interface design;
providing a means for selecting at least one form of said form set from the memory component on the basis of inputted customer data;
providing a means for mapping customer data in the results database structure to said selected form, defining a completed form; and
providing a means for printing said completed form.

25. The method of claim 24, further comprising the step of providing a design database structure, interactive with said interface means, for storing data defining said user interface design.

26. The method of claim 25, wherein said interface means is operable to store data defining said user interface design in said design database structure and to retrieve and load said data on a selected output component to provide an interactive visual display on the output component.

27. The method of claim 25, wherein said results database structure and said design database structure are a single database structure.

28. The method of claim 24 further comprising the step of providing a means for storing a plurality of form sets on said memory component, and wherein said system is operable to select and complete forms from a plurality of form sets, and wherein said interface means is operable to define a uniform user interface design for each form set of said plurality of form sets, and wherein data representing each user interface design is stored in said design database structure.

29. The method of claim 24, wherein said system includes a plurality of input and output components operable to be utilized by a plurality of users.

30. The method of claim 29, wherein said interface means is operable to define a user interface design including an interactive screen display of a script and inputted data in response to said script, said method further comprising the step, following the input of a first portion of data by a first user in response to said user interface design, of providing means for retrieving said screen display with said first portion of inputted data, and inputting a second portion of data in response to said user interface design.

31. The method of claim 24, further comprising the step of providing a customer database means for storage of customer data, and providing means for retrieving stored customer data from said customer database for input to the results database structure in response to said user interface design, relieving said user from obtaining said customer data from a customer.

32. The method of claim 24, further comprising the step of providing telephone communication means connected to said computerized system, the telephone communication means being operable by said user to receive calls from customers.

33. The method of claim 31, further comprising the step of providing telephone communications means connected to said computer system, the telephone communication means being operable by said user to receive calls from customers, and providing a caller identification means for identifying customers placing calls on said telephone communications means and retrieving customer information relating to said customers from said customer database.

34. The method of claim 24, wherein said results database structure includes at least three columns, the database structure operable to store a plurality of data modules, each data module including information provided by a selected customer in response to a specific data request of the script, each data module including a customer identifier for the customer providing information included in the data module, a data field for identifying the data request of the data module, and a data value for storing information provided by the customer in response to the data request of said data module.

35. The method of claim 25, wherein said design database structure includes at least three columns, the database structure being operable to store a plurality of data modules, each data module including information concerning a user interface design, each data module including an identifier, a field for describing the form set associated with said user interface design, and a file including the interface design for the form set of the interface design.

36. A computer readable medium for providing and using a database structure for selecting forms from a plurality of form sets and completing the selected forms with customer data, the medium comprising:
a program for defining user interface designs, each user interface design including a plurality of data requests in a script format applicable to the forms in a selected form set, the data requests designed to prompt the user to input customer data used by said program to select and complete forms most relevant to the customer from the forms of the form set;
a design database for storing said user interface designs, said design database including at least three columns and being operable to store a plurality of data modules, each data module having at least three items of information including an identifier, a field for describing the form set associated with the identifier, and a file containing at least a portion of each user interface design developed for the form set, modifications to the user interface designs being made by adding or deleting data modules and not by altering the database structure.
a results database that, on selection of an interface design from the design database, stores customer data obtained from customers in response to the script of the selected interface design, the results database including at least three columns and having data modules, each data module having at least three items of information, including a customer identifier, a data field associated with each data request in the script, and the value of the data field including customer information responsive to the data requests in the script associated with the data field;
a program for selecting a user interface design from the design database, displaying said design on a user screen display, and for inputting data values into said results database in response to said user interface design; and
a program for selecting at least one form from said form set and mapping data from said results database to said at least one form, to provide a completed form.

37. The computer readable medium of claim 36, wherein the design database and customer information database constitute one database.

38. The computer readable medium of claim 36, wherein each form set is a plurality of forms provided by a business entity.

39. The computer readable medium of claim 36, wherein each script of data requests is developed by analyzing the set of forms associated with the user interface design, to develop a set of questions organized in a decision tree format, the answers to which questions aid selection of a form of the form set and provide information to complete the selected form.

40. The computer readable medium of claim 36, further including a means for linking with a computer program outside the medium for obtaining data to be utilized by one or more of the programs of the medium.

41. The computer readable medium of claim 36, further including means for entering customer data to the results database transmitted through a web page accessed over the Internet.

42. The computer readable medium of claim 36, further including means for validating customer data inputted into the results database.

43. The computer readable medium of claim 36, further including means for calculating a score as customer data is inputted in response to the script, the value of the score affecting the presentation of data requests in the script and the form selected for particular customers.

44. The computer readable medium of claim 36, further including means providing access to multiple users for modifying customer data inputted in the results database through entering the customer identifier of each such customer.

45. The computer readable medium of claim 36, further comprising a program for instructing a printer to generate a printed form for each a completed form.

46. The computer readable medium of claim 36, wherein the medium is a compact disk,

47. The computer readable medium of claim 36, wherein the medium is a hard drive.

48. The computer readable medium of claim 36, wherein the medium is an electronic download of programs from a server accessed over the Internet.
